(19) United States
(12) Patent Application Publication
(10) Pub. No.: US 2003/0102972 A1
(43) Pub. Date: Jun. 5, 2003

(54) Self-locating personal alarm system equipped parachute

(76) Inventors: Dan Schlager, Tiburon, CA (US); Noah M. Schlager, Tiburon, CA (US); Samuel H. Schlager, Tiburon, CA (US)

Correspondence Address: ROBERT BUCKLEY, PATENT ATTORNEY, 462 N M ST., LIVERMORE, CA, 94551-2828, US

(21) Appl. No.: 10/010,971

(22) Filed: Dec. 4, 2001

(51) Int. Cl. G08B 23/00

(52) U.S. Cl. 340/573.1; 340/539.11; 340/539.13

(57) ABSTRACT

A parachute equipped with a self-locating personal alarm system remote unit includes a navigational receiver providing navigational information, a radio transmitter connected for transmitting the navigational information, and a circuit for activating the radio transmitter. In one embodiment the transmission of navigational information is voice activated. In another embodiment, the transmission is activated by depressing a panic button, while in a third embodiment, the transmission is activated by deployment of the parachute. In other specific embodiments, the radio transmitter is part of a wireless telephone permitting two-way voice communication, while the navigational information is provided by a GPS receiver and defines a location of the parachute. In yet other specific embodiments, the navigational information is an intermediate form and is transmitted to a base station where the computation of the parachute location is completed.

### RELATED DOCUMENTS

This Patent Application is related to, and incorporates by reference the disclosures of, U.S. Pat. No. 6,198,390, and of co-pending U.S. patent application Ser. No. 09/728,167, filed Dec. 1, 2000.

### FIELD OF THE INVENTION

The invention relates to personal alarm systems, and in particular to personal alarm systems that provide user location when a parachute is deployed.

### BACKGROUND ART

U.S. Pat. Nos. 5,650,770 and 5,963,130 disclose self-locating personal alarm systems and remote units having a variety of configurations. They do not disclose a parachute equipped with a self-locating personal alarm system remote unit. It would be useful to have such a combination.

### SUMMARY OF THE INVENTION

The present invention combines a navigational receiver and a radio transmitter with a parachute. The navigational receiver provides navigational information and the radio transmitter can be activated by voice, panic button, or simply by deploying the parachute. The electronics are self-contained, including batteries, and fit easily within the parachute harness worn by the aviator. When activated, the radio transmitter transmits navigational information for use in locating the aviator.

### BRIEF DESCRIPTION OF THE DRAWINGS

FIG. 1 is a pictorial and block diagram illustrating a self-locating personal alarm system remote unit equipped parachute according to one aspect of the present invention.

FIG. 2 is a partial block diagram illustrating use of a wireless telephone to provide a radio transmitter for the remote unit equipped parachute of FIG. 1.

FIG. 3 is a partial block diagram that illustrates an embodiment that activates transmission of navigational information by initiating a phone call to an emergency telephone number.

FIG. 4 is a block diagram that illustrates a self-locating personal alarm system in which the transmitted navigational information is in an intermediate form, and a base station completes a computation of the parachute location.

FIG. 5 is a block diagram illustrating a self-locating personal alarm system remote unit equipped parachute including a radio receiver permitting a two-way voice communication.

FIG. 6A is a front view of a parachute harness pocket for holding a self-locating personal alarm system remote unit.

FIG. 6B is a side view of the parachute harness pocket of FIG. 6A.

FIG. 7 is a partial block diagram illustrating a map display feature of another embodiment of the invention.

### DESCRIPTION OF THE PREFERRED EMBODIMENTS

This disclosure incorporates by reference the full disclosures of U.S. Pat. No. 6,198,390, issued Mar. 6, 2001, and the co-pending U.S. patent application Ser. No. 09/728,167, filed Dec. 1, 2000. In particular, portions of the '390 patent describe a personal alarm system remote unit having a GPS receiver providing a remote unit location, a radio transmitter connected for transmitting the remote unit location, a panic button connected for causing the radio transmitter to transmit the remote unit location, and a waterproof vest containing the GPS receiver, the radio transmitter, panic button (and power source such as batteries). The combination defines a “man-over-board vest.” Co-pending U.S. patent application Ser. No. 09/728,167 describes several voice-activated embodiments of the self-locating personal alarm system and personal alarm system remote unit.

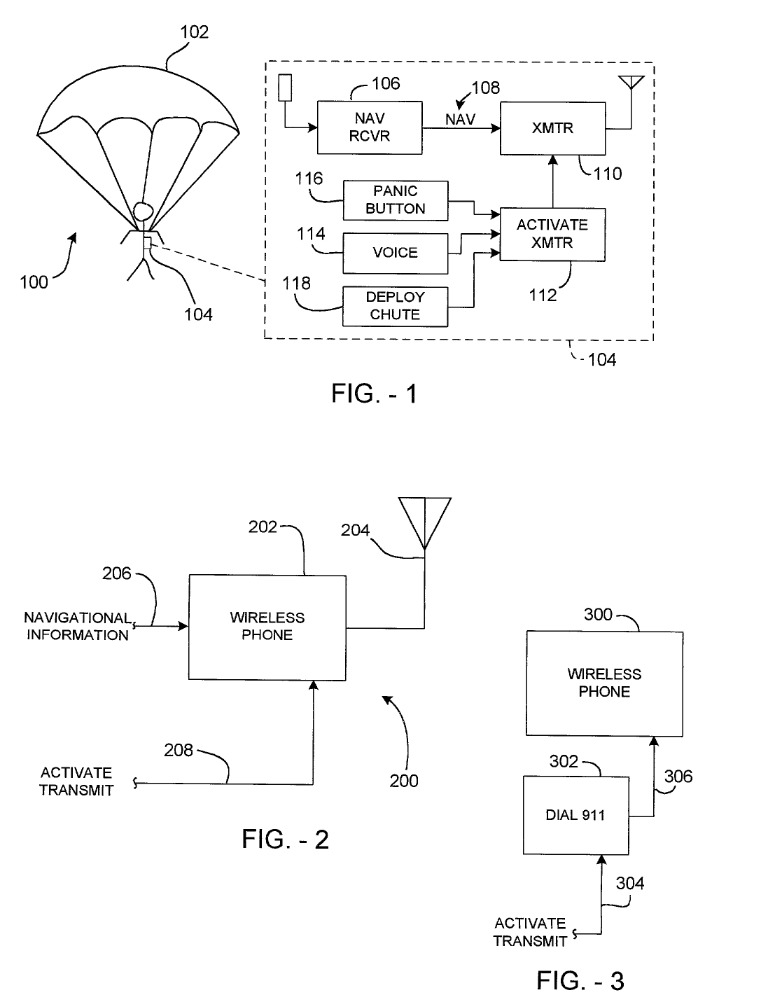

FIG. 1 is a pictorial and block diagram illustrating a self-locating personal alarm system remote unit equipped parachute according to one aspect of the present invention. The remote unit equipped parachute is designated generally by the reference numeral 100, and includes a parachute 102, a self-locating personal alarm system remote unit 104 incorporated into a parachute harness (not shown), self-contained batteries (not shown), a navigational receiver 106 providing navigational information 108 to a radio transmitter 110.

The present invention 100 combines a navigational receiver 106 with a radio transmitter 110 connected for transmitting navigational information when activated 112 by voice 114, panic button 116, or chute deployment 118. In a specific embodiment the chute is deployed automatically by any of a variety of known methods. A variety of navigational receivers are contemplated, and include but are not limited to the standard GPS receiver. In one embodiment the navigational information is presented as geo-coordinates defining the aviator's location. In an alternative embodiment the navigational information is an intermediate form not fully expressed as geo-coordinates nor actual location, and is transmitted to a base station for completion of the conversion to a specific location of the aviator.

In another specific embodiment, the radio transmitter function is provided by alternatively, one of a wireless, cellular, satellite telephone permitting two-way voice communication between the aviator and others.

In various specific embodiments, the navigational receiver is compatible with one of a geo-synchronous satellite global navigation system, the infrastructure-based TDOA and RSSI systems, the SATNAV system, and the LORAN system. The preferred embodiment is that the navigational receiver 106 is compatible with the U.S. GPS system.

FIG. 2 is a partial block diagram that illustrates the use of a wireless phone within a personal alarm system remote unit equipped parachute according to a specific embodiment of the present invention. The personal alarm system remote unit is designated generally by the reference numeral 200, and includes a wireless phone 202, a wireless phone antenna 204, navigational information 206, and an Activate-Transmit signal 208.

The wireless phone 202 typically includes elements necessary for two-way radio communication (full-duplex mode), such as a microphone and a speaker.

When the Activate-Transmit signal 208 becomes active, the wireless phone 202 transmits the navigational information 206.

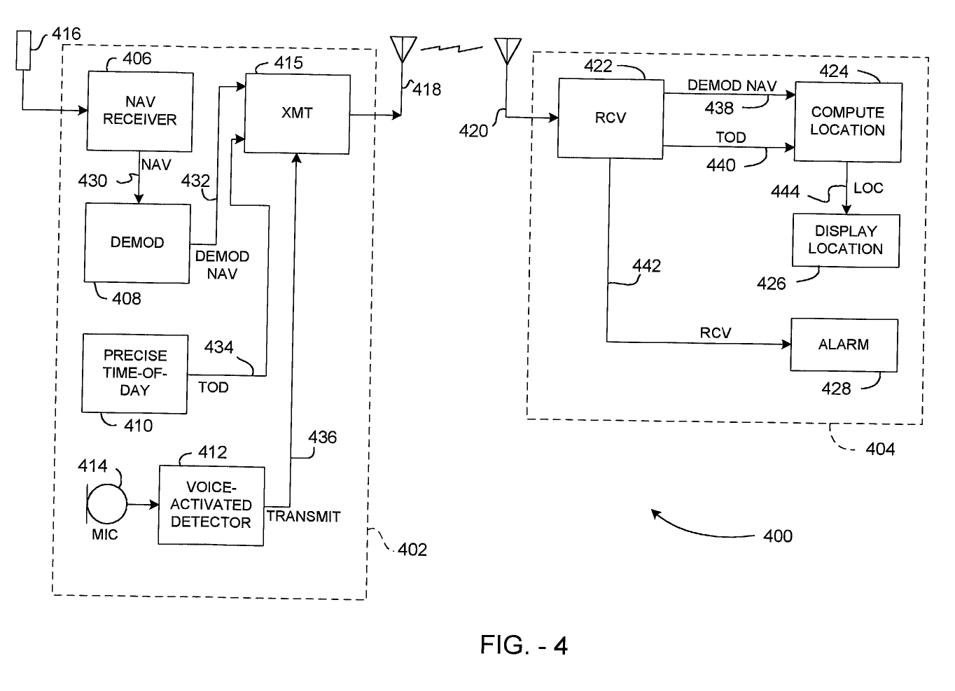

FIG. 3 is a partial block diagram illustrating the wireless phone of FIG. 2 and including a circuit that automatically dials “911” for transmitting the navigational information. The wireless phone is designated by the reference numeral 300, while the circuit that automatically dials “911” is designated by the reference numeral 302. When the Activate-Transmit signal 304 becomes active, the circuit 302 automatically dials the dedicated public safety help telephone number “911” via connection 306 with the wireless phone 300. Once the telephone connection with the 911 service is established, the wireless phone 300 transmits the navigational information. Recently, additional public safety help telephone numbers have been contemplated and, in some cases, assigned. A person having an ordinary level of skill in the relevant arts will appreciate that (1) the use of these additional telephone numbers is also contemplated by the present invention, and (2) a typical wireless phone includes a keypad permitting a user to place a call in the normal manner, including a call placed to a dedicated public safety help telephone number.

FIG. 4 is a block diagram of a personal alarm system according to another aspect of the present invention. The personal alarm system is designated generally by the reference numeral 400 and includes a remote unit 402 and a base station 404. In practice, the remote unit 402 is located within the harness of a parachute (not shown) and includes self-contained batteries (not shown).

The remote unit 402 includes a navigational receiver 406, a demodulator circuit 408, a precise time-of-day circuit 410, a voice-activated detector circuit 412, a microphone 414, a radio transmitter 415, a navigational receiver antenna 416, and a radio transmitter antenna 418.

The navigational receiver provides modulated navigational information 430 to the demodulator circuit 408. The demodulator circuit 408 “demodulates” the modulated navigational information 430 and provides demodulated navigational information 432 to the radio transmitter 415. The precise time-of-day circuit 410 provides a precise time-of-day signal 434 to the radio transmitter.

The microphone 414 is connected to the voice-activated detector circuit 412 permitting the detector circuit 412 to activate an output signal 436 when a predetermined distress phrase is detected, for example “HELP!”

The radio transmitter 415 is connected to transmit the demodulated navigational information 432 and the precise time-of-day information 434 when the voice-activated output signal 436 becomes active.

The base station 404 includes an antenna 420, a radio receiver 422, circuits 424 for computing the remote unit location, a display 426, and an alarm 428.

Radio transmissions from the remote unit 402 are received via the antenna 420 and converted by the radio receiver into demodulated navigational information 438, and precise time-of-day information 440. These are intermediate signals that must be manipulated to determine a precise location of the transmitting remote unit 402. The circuits 424 receive the demodulated navigational information and the precise time-of-day information and compute a global location 444 for the transmitting remote unit 402. The computed global location (in appropriate coordinates) is displayed on the display 426. The alarm 428 is activated by a receiver output signal 442 when a radio transmission from the remote unit is received.

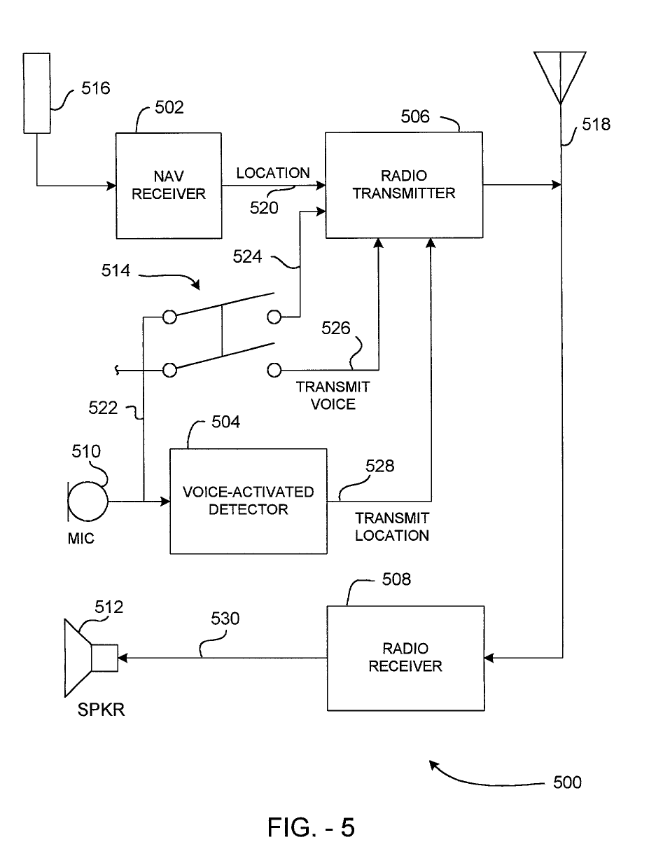

FIG. 5 is a block diagram that illustrates another embodiment of a personal alarm system remote unit for use with a parachute. The remote unit is designated generally by the reference numeral 500 and includes a navigational antenna 516, a navigational receiver 502, a microphone 510, a voice-activated detector 504, a radio transmitter 506, a radio antenna 518, a radio receiver 508, and a speaker 512.

The navigational receiver 502 receives navigational information via the navigational antenna 516 and provides a location 520 of the remote unit in appropriate coordinates.

The microphone 510 and the voice-activated detector 504 are connected to provide a Transmit Location signal 528 that becomes active when the detector 504 recognizes an audible, predetermined distress phrase such as “HELP!” The radio transmitter 506 is connected with the Transmit Location signal 528, and with the remote unit location information 520 so that the location information is transmitted when the signal 528 becomes active. Thus, in normal use, the remote unit 500 transmits its own location (in appropriate coordinates) when an audible, predetermined distress phrase is detected. The predetermined distress phrase is preset to a specific language. In another embodiment, the predetermined distress phrase is programmed into a programmable storage unit (not illustrated) that is connected with the voice-activated detector 504.

The remote unit 500 includes a switch 514 that connects the microphone 510 with the radio transmitter 506 for transmitting one-half of a two-way radio communication. The switch 514 also is connected to generate a Transmit Voice signal 526 that becomes active when the switch 514 is operated. The radio transmitter 506 is connected with the Transmit Voice signal 528 so that when the switch is operated, the microphone is connected for voice transmission in a push-to-talk arrangement (half-duplex mode), and the radio transmitter transmits the voice via radio antenna 518. The other half of the two-way radio communication is received by the radio antenna 518, then converted to audible sound by the radio receiver 508 and the speaker 512.

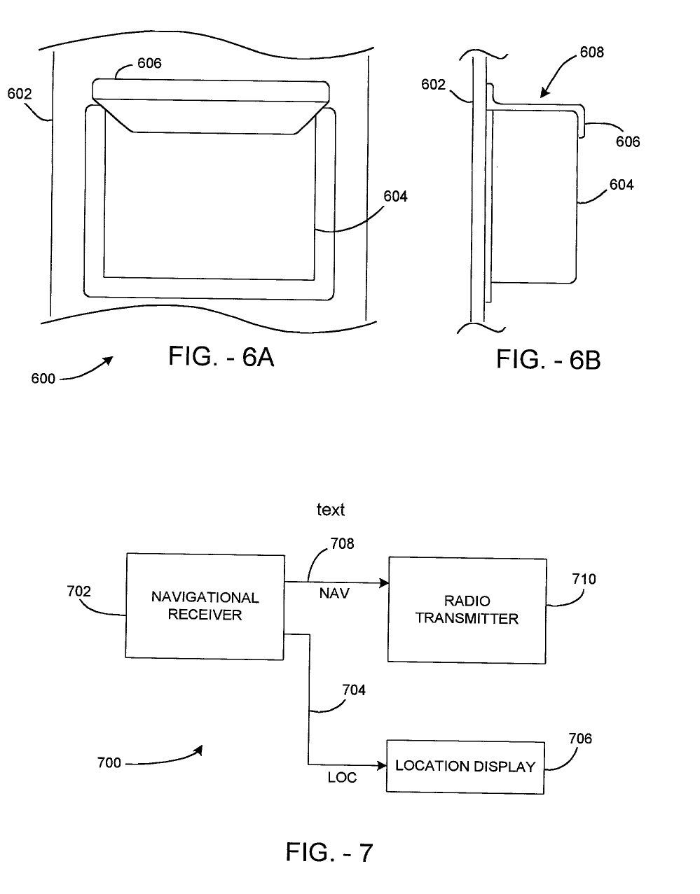

FIG. 6A is a front view of a parachute harness pocket for holding a self-locating personal alarm system remote unit. The parachute harness and pocket are designated generally by the reference numeral 600, and include a parachute harness (partial) 602, a pocket 604, and a pocket cover 606. The pocket 604 is attached to the harness by sewing, gluing, or other appropriate means. The pocket cover 606 opens to permit insertion of a self-contained, self-locating personal alarm system remote unit, such as illustrated in FIG. 1.

FIG. 6B is a side view of the parachute harness pocket of FIG. 6A showing that the remote unit 104 of FIG. 1 is placed inside (indicated generally by the numeral 608) the pocket 604.

Other types of fastening devices and arrangements that permit a self-contained, self-locating personal alarm system remote unit to be attached to the parachute harness will be known to those having an ordinary level of skill in the art. One feature of the embodiment of the invention shown in FIGS. 6A, 6B is that the remote unit may be easily removed after a parachute descent.

Another important aspect of a self-contained, self-locating personal alarm system remote unit suitable for use with the present invention is that the remote unit be shock and water resistant (not illustrated).

Finally, FIG. 7 is a partial block diagram that illustrates another embodiment of the present invention in which the remote unit includes a display for displaying the remote unit location in an appropriate coordinate system, such as a geo-coordinate system. The embodiment is designated generally by the reference numeral 700, and includes a navigational receiver 702, outputting remote unit location information 704, a location display 706, remote unit location navigational information 708, and a radio transmitter 710.

In use the navigational information 708 is connected to the radio transmitter for transmission to a base station such as shown in FIG. 4. The remote unit location information 704 is displayed via the location display 706, which in a particular embodiment is a standard liquid crystal display device.

While the invention has been described in relation to the embodiments shown in the accompanying Drawing figures, other embodiments, alternatives and modifications will be apparent to those skilled in the art. It is intended that the Specification be exemplary only, and that the true scope and spirit of the invention be indicated by the following claims.

1. A personal alarm system remote unit equipped parachute, comprising:
a navigational receiver providing navigational information relating to the remote unit location;
a radio transmitter connected for transmitting the navigational information;
means for activating a transmission of the navigational information; and
a parachute containing the navigational receiver, the radio transmitter, and the transmission activating means.

2. The alarm system remote unit equipped parachute of claim 1, wherein the transmission of navigational information is voice activated.

3. The alarm system remote unit equipped parachute of claim 1, wherein the transmission of navigational information is activated by pressing a panic button.

4. The alarm system remote unit equipped parachute of claim 1, wherein the transmission of navigational information is activated by deployment of the parachute.

5. The alarm system remote unit equipped parachute of claim 1, wherein the navigational receiver is a wireless assisted GPS receiver.

6. The alarm system remote unit equipped parachute of claim 1, wherein the navigational receiver is a hybrid GPS receiver.

7. The alarm system remote unit equipped parachute of claim 1, wherein the navigational receiver is a GPS receiver.

8. The alarm system remote unit equipped parachute of claim 7, wherein the navigational receiver provides demodulated GPS data and the radio transmitter transmits the demodulated GPS data and precise time-of-day information.

9. The alarm system remote unit equipped parachute of claim 7, wherein the navigational receiver provides calculated time delay of arrival location information, permitting the radio transmitter to transmit a location of the remote unit equipped parachute.

10. The alarm system remote unit equipped parachute of claim 1, wherein the radio transmitter is one of a cellular telephone, a PCS telephone, a satellite telephone, a wireless telephone, and a data-only wireless communication system.

11. A base station for receiving navigational information from an alarm system remote unit equipped parachute, and for displaying the parachute location.

12. The alarm system remote unit equipped parachute of claim 1, wherein the alarm system remote unit is detachable from the parachute harness.

13. The alarm system remote unit equipped parachute of claim 1, further including a GPS location display on the remote unit.

14. The alarm system remote unit equipped parachute of claim 1, wherein the alarm system remote unit is shock and water resistant.

15. A parachute for use with a self-locating personal alarm system remote unit, comprising:
a parachute having a harness;
the harness including means for attaching a self-contained self-locating personal alarm system remote unit; and
means for activating a held/attached remote unit when the parachute is deployed.

16. The parachute according to claim 15, wherein the attaching means is a pocket disposed on the harness, and a self-contained self-locating personal alarm system remote unit is placed within the pocket.

17. The parachute according to claim 15, wherein the attaching means is a fastener disposed on the harness, and wherein a self-contained self-locating personal alarm system remote unit is equipped with a compatible fastener for attaching to the harness.

18. A self-contained, self-locating alarm system remote unit for use with a parachute having means for activating the remote unit when the parachute is deployed.
